(19) United States
(12) Patent Application Publication
(10) Pub. No.: US 2009/0039656 A1
(43) Pub. Date: Feb. 12, 2009

(54) Energy Recovery System

(76) Inventors: Felipe Jose Farley, Simpsonville, SC (US); Jonathan David Farley, Simpsonville, SC (US)

Correspondence Address: Felipe Jose Farley, P.O. Box 716, Mauldin, SC, 29662, US

(21) Appl. No.: 11/835,299

(22) Filed: Aug. 7, 2007

(51) Int. Cl. H02K 7/18; F02B 63/04; F03G 7/08

(52) U.S. Cl. 290/1 R

(57) ABSTRACT

The present invention is an energy recovery system comprising:
a. A vehicle, including an apparatus creating braking, which apparatus is operatively connected to
b. An electric generator, electrically connected to
c. A non-radiative electrical energy transfer transmitter, operatively connected to
d. a non-radiative energy transfer receiver.

### FIELD OF THE INVENTION

The present invention is in the field of energy conservation and recovery.

### BACKGROUND OF THE INVENTION

Trains, trucks and automobiles travel many millions of miles every day in the United States. The U.S. is heavily dependent upon foreign sources for its oil, and increasingly concerned about the environmental effects of the use of fossil fuels. The present invention addresses both of these concerns.

### SUMMARY OF THE INVENTION

The present invention is an energy recovery system comprising:
a. A vehicle, including an apparatus creating braking, which apparatus is operatively connected to
b. An electric generator, electrically connected to
c. A non-radiative electrical energy transfer transmitter, operatively connected to

a non-radiative energy transfer receiver.

### BRIEF DESCRIPTION OF THE DRAWINGS

FIG. 1 is an illustration of the present invention.

FIG. 2 is an illustration of one embodiment of the present invention.

### DETAILED DESCRIPTION OF THE INVENTION

The present invention is an energy recovery system comprising:
a. A vehicle, including an apparatus creating braking, which apparatus is operatively connected to
b. An electric generator, electrically connected to
c. A non-radiative electrical energy transfer transmitter, operatively connected to
d. a non-radiative energy transfer receiver.

Trains, trucks, and automobiles travel many millions of miles in the United States, and around the world. Rolling resistance of truck and automobile tires is only about fifteen to twenty percent of the resistance an engine must overcome to propel a vehicle. The resistance of steel train wheels may be less than that. A better source for conservation of energy would be conserving the energy used to stop the vehicle, and then applying that energy to the vehicle to propel it, or to propel another vehicle. However, very few vehicles have regenerative braking apparatuses. Some electric trains have regenerative braking apparatuses, but for these, electric power generated from braking must be fed into an electret structure around the train. This is only present for electric trains.

However, following a suggestion of the great Nikola Tesla, many trains today have their engine cars power a generator, which feeds electricity to traction motors at the wheels, thus obviating the need for the complex mechanisms to transfer power present in trains of the 19^{th} century. However, for those trains, power is dissipated in a “dynamic braking grid”, a set of electrical resistors cooled by air. Thus the power is wasted.

The present invention uses the phenomenon of non-radiative transfer of electrical energy to transfer energy from a braking vehicle to storage, an electrical utility grid, or another vehicle in need of power. Thus braking energy is conserved. The non-radiative transfer of electrical energy has been described by Marin Soljacic (BBC News, 15 Nov. 2006, “Physics Promises Wireless Power,” reporter Jonathan Fildes; Aristeidis Karalis, J. D. Joannopoulos, and Marin Solja\check{c}ić, “Efficient Wireless mid-range non-radiative energy transfer”, Annals of Physics; Andre Kurs, Marin Soljacic, et al., “Wireless power transfer via strongly coupled magnetic resonances”, Science, vol. 317, 6 Jul. 2007). This mode of transfer of electrical energy may have been discovered by the great Nikola Tesla.

Briefly, one example of non-radiative transfer of electrical energy employs the following scheme. The transmitter may be a coil of copper, made to resonate at a frequency of 6.4 megahertz, say, and emits electromagnetic waves. This energy propagates several meters, to a receiver, which may also be a coil of copper wire, made to resonate at 6.4 megahertz. This method of wireless transmission and reception is considered to be different and far more efficient at a distance than induction.

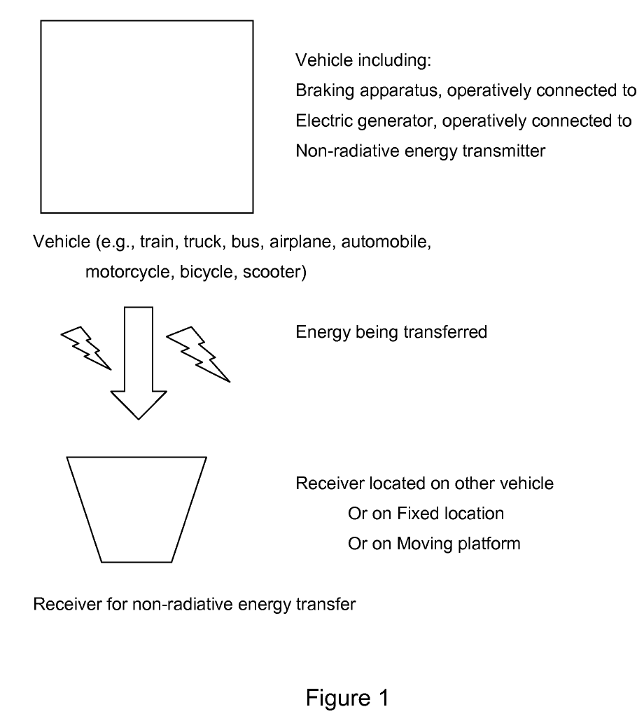

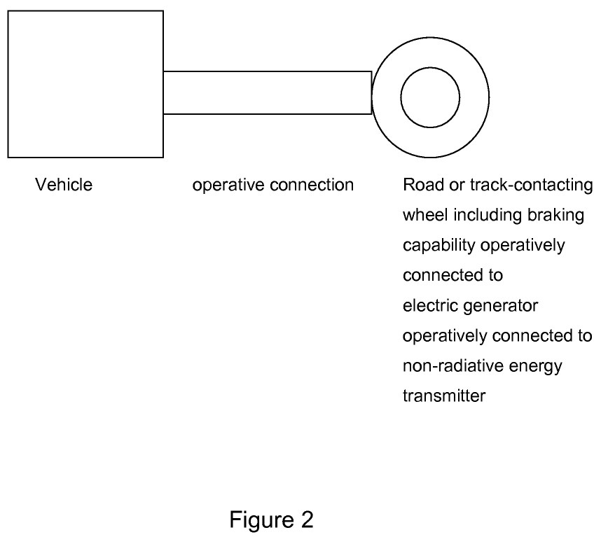

According to the present invention, transmitters for non-radiative energy would be operatively coupled to an apparatus which would act to brake a vehicle. The operative coupling could be a mechanical, pneumatic, hydraulic, or magnetic connection to the braking system of the vehicle, an extra ground or track contacting wheel, or the engine system, to help provide what is known as “engine braking”. (See FIGS. 1 and 2) In one embodiment of the invention, vehicles would be outfitted with magnetic brakes, such as are in many trains, which generate current as a consequence of braking. In another embodiment of the invention, an extra ground or track contacting wheel would be added to retrofit vehicles, and this wheel would be operatively connected to an electric generator, and operatively connected to the non-radiative energy transmitter. The braking controls of the vehicle would be operatively connected to this extra wheel. In another embodiment of the invention, a second vehicle would include a receiver for reception of non-radiatively transferred electrical energy, which receiver would be electrically connected to an electric motor.

Note that the same vehicle, if including an electric motor, might have a transmitter for sending non-radiative energy and a receiver for receiving non-radiative energy. A vehicle including only a combustion engine might only have a transmitter for transmitting non-radiative energy.

Imagine an 8,000 ton coal train coming to a stop from 50 miles per hour. Assuming electrical energy costs 8 cents per kilowatt hour, one can make the following calculations: Kinetic energy in joules equals one-half multiplied by mass multiplied by velocity squared.
3,600,000 joules equals one kilowatt-hour
   That means a single train stop uses about $80.50 worth of electricity. Now, a car may weigh only 2 tons. So each car stop from fifty miles per hour may use only the equivalent of 2 cents worth of electricity. However, a single busy intersection of a major American city might have 100,000 cars a day stopping and starting. And when travelling just a few miles in a city, a driver may come to a dead stop from fifty miles an hour an hundred or more times. The monetary amounts of energy wasted simply as heat in the brakes quickly adds up. Note that many cars today are hybrid cars, making use of both electric motors and gasoline motors (as are some modern military vehicles). Therefore, the present invention could provide electric power to such vehicles, as well as provide energy recovery.

A government entity may well decide to make mandatory the recovery of braking energy, determining that it is in the interest of society to recover energy—energy from a non-renewable source—that otherwise would be wasted simply as heat in vehicle brakes. Even if such energy recovery were not made mandatory, many jurisdictions already provide that electric utilities must buy back power generated by customers. A railroad may find it in its economic interest to sell the electric energy generated from braking to the local utility. A bus company may also find it in its interest to sell the power generated from braking, even simply at bus stations and stops, to the local electric utility.

Electric power lines often run parallel to train tracks and roads. Therefore, receivers for non-radiative power transfer could be linked to the existing electrical grid. In remote areas, however, braking power expended going down a hill or a mountainside could still be captured. Nikola Tesla, in his U.S. Pat. No. 1,119,732, and patents cited therein, describes a system for wireless transmission of electrical energy through the earth. The non-radiative transmitter in the vehicle could transmit power to a non-radiative receiver, which is electrically linked to a transmitter such as that described in the U.S. Pat. No. 1,119,732.

Since non-radiative energy transfer occurs only over a moderate distance, it may be necessary to have receivers set up at regular intervals at likely braking points for vehicles. At train stations, non-radiative energy receivers and transmitters could be set up on a movable platform so that it stays within a few meters of the train's non-radiative transfer transmitter as the train comes to a stop, or as the train accelerates from a stop.

In another embodiment of the invention, information such as vehicle location, weight, likely destination, velocity, weather conditions, and road conditions could be transmitted and received by system users. That way vehicle routes could be planned so as to provide the maximum recovery of braking energy generated by vehicles in the locality. Routes could also be planned so that a heavy truck, for instance, might go once a day down a rural route including a flywheel for the storage of energy, and thereby provide sufficient power for electric bicycle and scooter riders to go up a nearby hill all day, making use of non-radiative energy transmitters spaced at intervals along the roadway.

Construction companies and mining companies might also wish to recover the energy used in braking their many-ton vehicles on site. Airplanes might also use this system at airports to recover some of the energy used in braking. Tanks and other military vehicles could make use of this system.

Other embodiments are described as follows:
The energy recovery system as described above, wherein the vehicle is selected from the group consisting of: trains, trucks, buses, automobiles, airplanes, lorries, trams, motorcycles, tricycles, bicycles, scooters, skateboards, and roller skates. Note that a vehicle such as a bicycle or a scooter, normally powered by the muscles of the rider, could be outfitted with an auxiliary electric motor electrically coupled to a receiver for non-radiative energy. Thus a vehicle could include an electric generator, electrically coupled to a transmitter for non-radiative energy, and also include a receiver for non-radiative energy, electrically coupled to an electric motor. The electric motor could be in addition to whatever other type of motor the vehicle used. The non-radiative energy receiver could also be coupled to a boiler for producing steam, and driving a steam engine. In this manner the received electrical energy could be stored for a time for later use in the form of steam. (It could also be stored in other manners known to those of ordinary skill in the art, such as mechanically, in springs or flywheels, or in capacitors or batteries).
The energy recovery system wherein the non-radiative energy receiver is located at sites selected from the group consisting of: fixed ground locations, other vehicles, and movable platforms.
The energy recovery system wherein the non-radiative energy receiver is electrically connected to a mechanism selected from the group consisting of: motors, energy storage mechanisms, and electric power grids.
The energy recovery system wherein the energy storage mechanism is selected from the group consisting of: mechanical, chemical, and electrical energy storage mechanisms.
The energy recovery system wherein the mechanical energy storage mechanisms are selected from the group consisting of: flywheels, springs, air compressors, steam boilers, and devices to lift a mass against the force of gravity; and wherein the chemical energy storage mechanism is selected from the group consisting of batteries and capacitors; and wherein the electrical energy storage mechanism is selected from the group consisting of capacitors. When a mass is lifted against the force of gravity, the force of gravity driving the mass to earth can drive a mechanism to drive an electric generator.
The energy recovery system further comprising the system wherein the receiver is operatively connected to a mechanism selected from the group consisting of: a second non-radiative energy transfer transmitter, and a device to transmit electrical energy directly through the earth.
The energy recovery system wherein the locations for receivers of non-radiative energy are selected from the group consisting of railroad tracks, tunnels, roadways, airports, airstrips, walkways, bicycle paths, and construction sites.
The energy recovery system wherein the locations for receivers of non-radiative energy, wherein the locations are further selected from the group of locations requiring braking of a vehicle, consisting of railroad stations, rail yards, construction sites, mines, railroad bridges, road intersections, traffic stops, military bases, outposts and staging areas, declines, parking lots, parking decks, places where traffic jams occur.
The energy recovery system further comprising wherein the braking apparatus comprises an additional wheel contacting the surfaces selected from the group consisting of ground, roadway or track, wherein said wheel is operatively connected to the electric generator.
The energy recovery system further comprising:
e. A geographic position locator for the vehicles; operatively connected to
f. Means for transmitting and receiving information selected from the group consisting of vehicle location, destination, speed, direction, mass, time of day, traffic density, road conditions, weather conditions, and estimated travel times;
   thereby permitting greater use of energy of braking of vehicles.

The energy recovery system further comprising the sale of said energy. Note that vehicles can include an electricity meter to measure the electrical energy generated or used by the vehicle.

The energy recovery system further comprising wherein vehicles are selected from the group consisting of stationary bicycles and exercise machines.

The energy recovery system wherein the vehicles form a caravan, and energy from the braking of one vehicle is transmitted non-radiatively to a second vehicle. In this embodiment, a vehicle including both a non-radiative energy receiver and a non-radiative energy transmitter can act as a relay station for transmission of energy along portions of the length of the caravan.

I claim:

1. An energy recovery system comprising:
a. A vehicle, including an apparatus creating braking, which apparatus is operatively connected to
b. An electric generator, electrically connected to
c. A non-radiative electrical energy transfer transmitter, operatively connected to
d. A non-radiative energy transfer receiver.

2. The system of claim 1, wherein the vehicle is selected from the group consisting of: trains, trucks, buses, automobiles, airplanes, lorries, tanks, military vehicles, trams, motorcycles, tricycles, bicycles, scooters, skateboards, and roller skates.

3. The system of claim 1, wherein the receiver is located at sites selected from the group consisting of: fixed ground locations, other vehicles, and movable platforms.

4. The system of claim 1, wherein the receiver is electrically connected to a mechanism selected from the group consisting of: motors, energy storage mechanisms, and electric utility power grids.

5. The system of claim 4, wherein the energy storage mechanism is selected from the group consisting of: mechanical, chemical, and electrical energy storage mechanisms.

6. The system of claim 5, wherein the mechanical energy storage mechanisms are selected from the group consisting of: flywheels, springs, air compressors, steam boilers, and devices to lift a mass against the force of gravity; and wherein the chemical energy storage mechanism is selected from the group consisting of batteries and capacitors; and wherein the electrical energy storage mechanism is selected from the group consisting of capacitors.

7. The system of claim 1 further comprising the system wherein the receiver is operatively connected to a mechanism selected from the group consisting of: a second non-radiative energy transfer transmitter, and a device to transmit electrical energy directly through the earth.

8. The system of claim 3, wherein the locations are selected from the group consisting of railroad tracks, tunnels, roadways, airports, airstrips, walkways, bicycle paths, and construction sites.

9. The system of claim 8, wherein the locations are further selected from the group of locations requiring braking of a vehicle, consisting of railroad stations, rail yards, construction sites, mines, railroad bridges, road intersections, traffic stops, declines, military bases, outposts, staging areas, parking lots, parking decks, places where traffic jams occur.

10. The system of claim 1, further comprising wherein the braking apparatus comprises an additional wheel contacting the surfaces selected from the group consisting of ground, roadway or tracks, wherein said wheel is operatively connected to the electric generator.

11. The system of claim 1, further comprising:
e. A geographic position locator for the vehicles; operatively connected to
f. Means for transmitting and receiving information selected from the group consisting of vehicle location, destination, speed, direction, mass, time of day, traffic density, road conditions, weather conditions, and estimated travel times;
thereby permitting greater recovery of energy of braking of vehicles.

12. The system of claim 1, further comprising the sale of said energy.

13. The system of claim 2, further comprising wherein vehicles are selected from the group consisting of stationary bicycles and exercise machines.

14. The system of claim 3, wherein the vehicles form a caravan, and energy from the braking of one vehicle is transmitted non-radiatively to a second vehicle.

15. A vehicle including a non-radiative energy transmitter and a non-radiative energy receiver.

16. The vehicle of claim 15, wherein the vehicle includes a braking apparatus and an electric motor, wherein the non-radiative energy transmitter is operatively coupled to an electric generator which is operatively coupled to the braking system, and wherein the non-radiative energy receiver is operatively coupled to an electric motor.

17. A vehicle, including an apparatus creating braking, which apparatus is operatively connected to
a. An electric generator, electrically connected to
b. A non-radiative electrical energy transfer transmitter.
